(19) United States
(12) Patent Application Publication
(10) Pub. No.: US 2016/0000287 A1
(43) Pub. Date: Jan. 7, 2016

(54) ELECTRONIC DEVICE AND SELF-PROPELLED VACUUM CLEANER

(71) Applicant: SHARP KABUSHIKI KAISHA, Osaka-shi, Osaka (JP)

(72) Inventors: Masanori TSUBOI, Osaka-shi (JP); Toshihiro SENOO, Osaka-shi (JP); Mami YATAKE, Osaka-shi (JP)

(73) Assignee: Sharp Kabushiki Kaisha, Osaka-shi, Osaka (JP)

(21) Appl. No.: 14/770,856

(22) PCT Filed: Feb. 18, 2014
(86) PCT No.: PCT/JP2014/053759

§ 371 Date: Aug. 27, 2015

(30) Foreign Application Priority Data
Apr. 12, 2013 (JP) 2013-083884

(51) Int. Cl. A47L 9/28; G08B 21/18

(52) U.S. Cl. CPC A47L 9/2805; A47L 9/2852; A47L 9/2857; G08B 21/182; A47L 2201/00

(57) ABSTRACT

Provided is an electronic device including a surrounding environment detection unit which detects surrounding temperature and humidity, a message control unit which determines a type of an effect of the temperature and the humidity which are detected by the surrounding environment detection unit on human health risk and/or sensation of comfort, and generates a message in accordance with the type, and a voice output unit which outputs the generated message, in which the message control unit generates the message in response to a change of the determined type of the effect.

### TECHNICAL FIELD

This invention relates to an electronic device which generates a message in accordance with a surrounding environment, and, particularly, a self-propelled vacuum cleaner of the aforementioned electronic device.

### BACKGROUND ART

In recent years, there has been a problem of warming in urban areas due to, for example, the heat island phenomenon in which, compared to suburbs, temperatures of urban areas become higher. Interest in prevention of and a countermeasure against heat stroke during summer is increasing.

On the other hand, with an increase in the elderly population, reports on resistant bacteria, and the like, interest in prevention of and a countermeasure against influenza is increasing.

In such a situation, a thermohygrometer which notifies a state of air for which a degree of risk of influenza or heat stroke increases with three methods of an icon, sound, and light has been available on the market (for example, refer to NPL 1).

Moreover, a thermometer has been known that when a temperature that may cause heat stroke is reached, the strength of information, such as light, vibrations, or sound, to the five senses is increased in a stepwise manner and cautions are given (for example, refer to PTL 1).

Further, a pedometer has been known that calculates a thermal index (specifically, WBGT or Wet Bulb Globe Temperature) related to prevention of heat stroke by measurement values of temperature and humidity and displays a calculated numerical value and information (display or an alarm) based on the value (for example, refer to PTL 2).

### CITATION LIST

### Patent Literature

PTL 1: Japanese Unexamined Patent Application Publication No. 2003-344175

PTL 2: Japanese Unexamined Patent Application Publication No. 2011-192247

### Non Patent Literature

NPL 1: Product information, a temperature-humidity warning meter “goud” OND-01 series, [online], ELECOM CO., LTD., [retrieved on Mar. 13, 2013], Internet <URL: http://www2.elecom.co.jp/life-goods/thermometer/ond-01/index.asp>

### SUMMARY OF INVENTION

### Technical Problem

The above-described device is a thermohygrometer or a pedometer which aims to perform measurement related to temperature and humidity or exercise, and purchasers of the device are limited to people who have an interest in prevention of heat stroke or the like.

However, topics related to weather or temperature are naturally included in conversation in our everyday life. That is, conventionally, such topic is frequent content of communication.

On the other hand, in recent years, household electric robots are becoming widespread. The robots here are not limited to robots in a narrow sense such as a humanoid resembling a human and a so-called pet robot resembling a pet. They are rather robots in a broad sense including an electronic device which is a familiar household electric appliance represented by a vacuum cleaner or a washing machine developed to perform autonomous operation by applying many sensors, actuators, a microcomputer for controlling them, and the like.

Some of such household electric robots are able to communicate with a human by using voice synthesis or voice recognition.

The invention has been made considering the above circumstances, and provides an electronic device which is able to measure data of an environment such as surrounding temperature and humidity and to provide useful and appropriate information to a user.

### Solution to Problem

The invention provides an electronic device including a surrounding environment detection unit which detects surrounding temperature and humidity, a message control unit which determines a type of an effect of the temperature and the humidity which are detected by the surrounding environment detection unit on human health risk and/or sensation of comfort, and generates a message in accordance with the type, and a voice output unit which outputs the generated message, in which the message control unit generates the message in response to a change of the determined type of the effect.

In addition, the invention provides a self-propelled vacuum cleaner including the above-described electronic device and further including a propelling unit which propels the self-propelled vacuum cleaner in an area to be cleaned, a dust suction and collection unit which sucks and collects dust, and a control unit which controls operation of the propelling unit and the dust suction and collection unit, in which the message control unit suppresses generation of the message during a period when the control unit operates the propelling unit and the dust suction and collection unit.

### Advantageous Effects of Invention

Each of an electronic device and a self-propelled vacuum cleaner of the invention is provided with a message control unit which determines a type of an effect of temperature and humidity which are detected by a surrounding environment detection unit on a human health risk and/or sensation of comfort and generates a message in accordance with the type, in which the message control unit generates the message in response to a change of the determined type of the effect, so that, when there is a change in the surrounding environment regarding the human health risk and the sensation of comfort, it is possible to provide information related to the change. A user is able to utilize the provided information for health care and adjustment of the environment.

Furthermore, the self-propelled vacuum cleaner of the invention suppresses generation of the message during traveling and during a period when the dust suction and collection unit is operated for performing suction or exhaust of air, because a change in detection of the surrounding temperature and humidity easily occurs during traveling and the period. Thus, the message is generated based on the surrounding temperature and humidity which are detected accurately. Moreover, it is also possible to provide information which is helpful, for example, for health care of a user outside a period of cleaning work, which is an original function of the vacuum cleaner.

### BRIEF DESCRIPTION OF DRAWINGS

FIG. 1 is a block diagram illustrating a schematic configuration of a self-propelled vacuum cleaner which is one mode of an electronic device according to the invention.

FIG. 2 is a plan view illustrating one embodiment of the self-propelled vacuum cleaner according to the invention.

FIG. 3 is a side view illustrating the one embodiment of the self-propelled vacuum cleaner according to the invention.

FIG. 4 is a front view illustrating the one embodiment of the self-propelled vacuum cleaner according to the invention.

FIG. 5 is a sectional view taken along A-A of the self-propelled vacuum cleaner illustrated in FIG. 4.

FIG. 6 is a sectional view taken along B-B of FIG. 3.

FIG. 7 is a first flowchart illustrating one example of processing executed by a message control unit according to the invention.

FIG. 8 is a second flowchart illustrating one example of the processing executed by the massage control unit according to the invention.

FIG. 9 is an explanatory diagram illustrating one specific example of data stored by a correlation storage unit according to the invention.

FIG. 10 is an explanatory diagram illustrating a way that a message storage unit according to the invention stores Japanese messages corresponding to each of risk levels and divisions.

FIG. 11 is an explanatory diagram illustrating a way that the message storage unit according to the invention stores Japanese messages corresponding to each of the risk levels and divisions, and accumulated usage periods.

FIG. 12 is an explanatory diagram illustrating English messages corresponding to FIG. 10.

FIG. 13 is a flowchart illustrating one example of processing executed by the message control unit instead of the processing of FIG. 8 in an embodiment 2.

### DESCRIPTION OF EMBODIMENTS

Hereinafter, the invention will be described in further detail with reference to drawings. Note that, the description below is an exemplification in all respects, and should not be understood as a limitation of the invention.

### <<Configuration of Self-Propelled Vacuum Cleaner>>

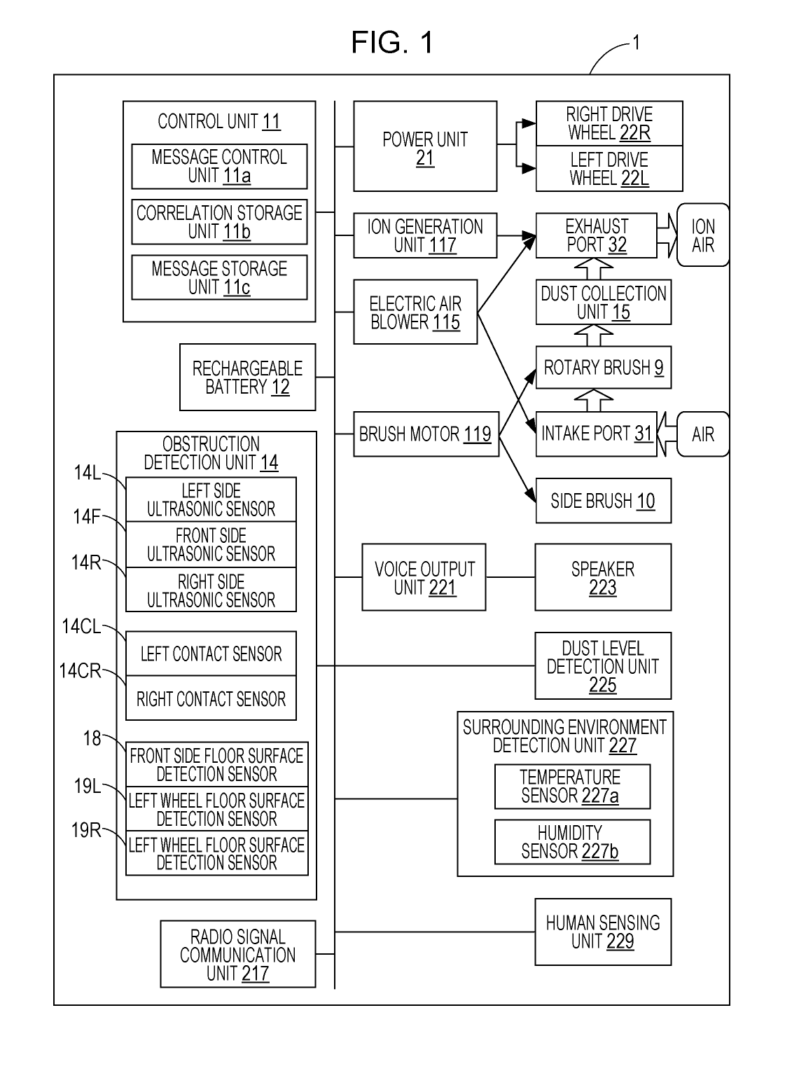

FIG. 1 is a block diagram illustrating a schematic configuration of a self-propelled vacuum cleaner which is one mode of an electronic device according to the invention. As illustrated in FIG. 1, the self-propelled vacuum cleaner according to the invention is provided mainly with a rotary brush 9, side brushes 10, a control unit 11, a rechargeable battery 12, an obstruction detection unit 14, and a dust collection unit 15. In addition, a power unit 21, a right drive wheel 22R, a left drive wheel 22L, an intake port 31, an exhaust port 32, an electric air blower 115, an ion generation unit 117, and a radio signal communication unit 217 are provided. Furthermore, a voice output unit 221, a speaker 223, a dust level detection unit 225, and a surrounding environment detection unit 227 are provided. Moreover, a human sensing unit 229 may be provided.

The power unit 21, the left drive wheel 22L and the right drive wheel 22R correspond to a propelling unit in a preferable mode of the invention (described below).

The rotary brush 9, the side brushes 10, the dust collection unit 15, the intake port 31, the exhaust port 32, the electric air blower 115 and a brush motor 119 correspond to a dust suction and collection unit of the preferable mode of the invention (described below).

The self-propelled vacuum cleaner of the invention is a self-propelled vacuum cleaner which, while autonomously traveling in an area to be cleaned, sucks air in the area, which includes dust, and exhausts air from which the dust is removed to thereby clean the aforementioned area. The self-propelled vacuum cleaner according to the invention has a function of autonomously returning to a not-shown charging stand after finishing cleaning.

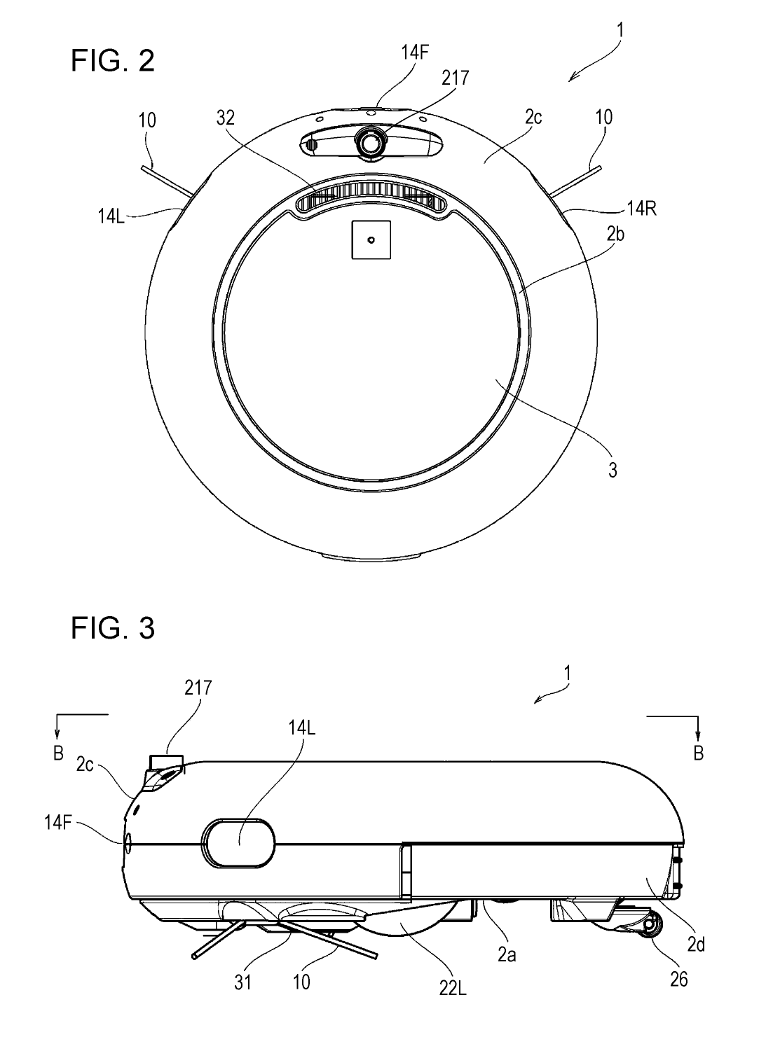

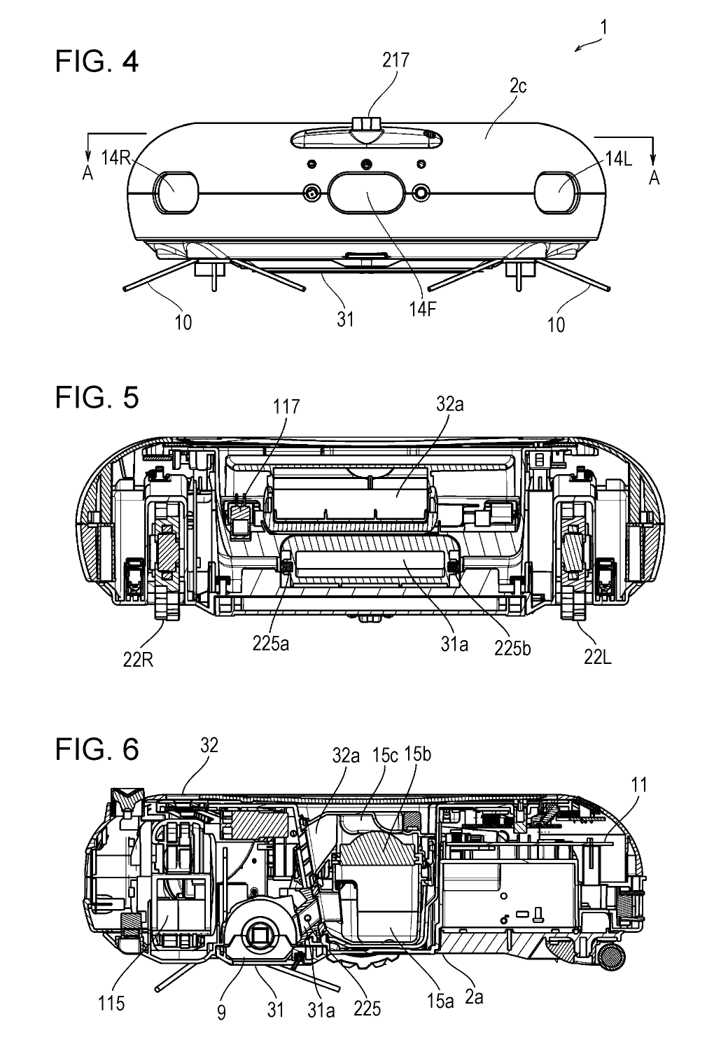

FIGS. 2 to 4 are views of an external appearance illustrating one embodiment of the self-propelled vacuum cleaner according to the invention. FIG. 2 is a plan view, FIG. 3 is a side view, and FIG. 4 is a front view.

FIG. 5 is a sectional view taken along A-A of the self-propelled vacuum cleaner illustrated in FIG. 4. Moreover, FIG. 6 is a sectional view taken along B-B of FIG. 3.

As illustrated in FIGS. 2 to 6, the external appearance of a self-propelled vacuum cleaner 1 is a disk shape.

The self-propelled vacuum cleaner 1 has a bottom plate 2a mounting an inner mechanism of the cleaner thereon and a top plate 2b in which a concave part for containing the dust collection unit 15 therein is formed. An edge of a rear half of the bottom plate 2a is surrounded by a rear-side side plate 2d. On the top plate 2b, a lid 3 which covers an upper-side opening part of the aforementioned concave part 213 is arranged so as to be openable and closable.

An outer peripheral part of the self-propelled vacuum cleaner 1 and an upper edge part from the outer peripheral part to the lid are covered by a bumper 2c which has a ring shape in plan view. The bumper 2c is fixed in a state of being displaceable to some extent in a horizontal direction with respect to the top plate 2b.

In a front side of a front surface of the bumper, a front side ultrasonic sensor 14F is arranged, and in a left front side, a left side ultrasonic sensor 14L is arranged. Moreover, in a right front side, a right side ultrasonic sensor 14R is arranged.

In a front-side upper part of the bumper 2c, a radio signal communication unit 217 is arranged so as to protrude upwardly. The radio signal communication unit 217 receives a radio signal from a radio signal transmitter of an operation remote controller or the charging stand, which is not shown. Moreover, the radio signal communication unit 217 is able to transmit the radio signal to perform remote control of an air conditioning device in a room. That is, it is possible to transmit the radio signal equivalent to a signal of the remote controller for controlling the air conditioning device. The control unit 11 is a microcomputer mounted on a circuit board, a memory, and a peripheral circuit, and controls traveling and other operations of the self-propelled vacuum cleaner 1 in response to an instruction indicated by the radio signal. In this embodiment, the radio signal communication unit 217 is attached to the bumper 2c.

Formed in the bottom plate 2a are a plurality of hole parts through which the right drive wheel 22R, the left drive wheel 22L, and a rear wheel 26 are caused to protrude downwardly so as to be exposed from the bottom plate 2a. Further, in the bottom plate 2a, the intake port 31 is formed, and the rotary brush 9 is arranged in a back thereof, the side brushes 10 are arranged to the right and left of the intake port 31, a front side floor surface detection sensor 18 is arranged in a front end part, a left wheel floor surface detection sensor 19L is arranged in a front side of the left drive wheel 22L, and a right wheel floor surface detection sensor 19R is arranged in a front side of the right drive wheel 22R.

When the right drive wheel 22R and the left drive wheel 22L rotate normally in a same direction, the self-propelled vacuum cleaner 1 advances and travels in a direction in which the front side ultrasonic sensor 14F is arranged. Moreover, the self-propelled vacuum cleaner 1 reverses when the right and left drive wheels rotate reversely in the same direction, and turns when rotating in directions opposite to each other. For example, in the case of arriving at a periphery of a cleaning area according to each sensor of the obstruction detection unit 14 and in the case of detecting an obstruction on a course, the self-propelled vacuum cleaner 1 causes the right and left drive wheels to stop after decelerating. Thereafter, the right and left drive wheels are caused to rotate in directions opposite to each other for turning and changing orientation. In such a manner, the self-propelled vacuum cleaner 1 autonomously travels while avoiding obstructions throughout an entire area where the self-propelled vacuum cleaner 1 is placed or a whole of a desired range.

Here, it is set that the front side refers to a forward travelling direction of the self-propelled vacuum cleaner 1 (in FIG. 2, an upper side along a sheet surface), and a rear side refers to a backward travelling direction of the self-propelled vacuum cleaner 1 (in FIG. 2, a lower side along the sheet surface).

Hereinafter, each component illustrated in FIG. 1 will be described.

The control unit 11 of FIG. 1 is a portion which controls operation of each component of the self-propelled vacuum cleaner 1, and which is realized mainly by a microcomputer composed of a CPU, a ROM which is a rewritable nonvolatile memory, a RAM used as a work memory, an I/O controller, a timer, and the like.

Based on a control program which is stored in the aforementioned ROM in advance and developed in the RAM, the CPU causes each hardware item to operate organically to thereby execute a cleaning function, a traveling function, etc. of the invention.

The control unit 11 includes functions of a message control unit 11a, a correlation storage unit 11b, and a message storage unit 11c. When the aforementioned CPU executes a module related to processing of message control of the aforementioned control program, the function of the message control unit 11a is realized. In the aforementioned ROM, the correlation storage unit 11b is a portion for storing data in which effects of surrounding temperature and humidity on human health risk and sensation of comfort are classified. In the aforementioned ROM, the message storage unit 11c is a portion for storing data regarding a message.

The rechargeable battery 12 is a portion for supplying power to each functional element of the self-propelled vacuum cleaner 1, and which is a portion for supplying power mainly for performing the cleaning function and traveling control. For example, a rechargeable battery such as a lithium ion battery, a nickel-metal hydride battery, or an Ni—Cd battery is used. Though being hidden behind the control unit 11 in FIG. 5, the rechargeable battery 12 is arranged downwardly thereof.

Charging of the rechargeable battery 12 is performed by, in a state where the self-propelled vacuum cleaner 1 is caused to be close to the not-shown charging stand, causing both charging terminals, which are exposed, to make contact with each other.

The obstruction detection unit 14, particularly each of the sensors 14L, 14F, and 14R in the left, front, and right sides, is a portion for detecting that the self-propelled vacuum cleaner 1 makes contact with or comes close to an obstruction such as a wall, a desk, or a chair in a room during traveling. The obstruction detection unit 14 detects proximity to the obstruction by using an ultrasonic sensor. Instead of the ultrasonic sensor, or with the ultrasonic sensor, a non-contact sensor of another type such as an infrared ranging sensor may be used.

A left contact sensor 14CL and a right contact sensor 14CR are arranged in an inner side of the bumper 2c in order to detect that the self-propelled vacuum cleaner 1 makes contact with an obstruction during traveling. The CPU comes to recognize a collision of the bumper 2c with the obstruction and a direction thereof based on an output signal from the left contact sensor 14CL and the right contact sensor 14CR.

The front side floor surface detection sensor 18, the left wheel floor surface detection sensor 19L, and the right wheel floor surface detection sensor 19R detect a level difference such as that of a descending staircase.

The CPU recognizes a position where an obstruction or a level difference exists based on the signal output from the obstruction detection unit 14. Based on position information of the recognized obstruction or level difference, a direction in which traveling is to be performed next after avoiding the obstruction or the level difference is determined. Note that, the left wheel floor surface detection sensor 19L and the right wheel floor surface detection sensor 19R are to detect a level difference in a left front side or a right front side in the forward travelling direction, which is out of a detection range of the front side floor surface detection sensor 18. Thereby, the descending staircase is detected, and the self-propelled vacuum cleaner 1 is prevented from falling down the descending staircase.

The power unit 21 is a portion for realizing traveling by drive motors for causing the right and left drive wheels of the self-propelled vacuum cleaner 1 to rotate or stop. The power unit 21 is configured so as to be able to rotate the left drive wheel 22L and the right drive wheel 22R independently in both the normal and reverse directions with the respective drive motors. Thereby, it is possible to realize traveling states of the self-propelled vacuum cleaner 1 such as advance, reverse, turn, and acceleration and deceleration.

The intake port 31 and the exhaust port 32 are portions for performing intake and exhaust of air for cleaning, respectively.

The dust collection unit 15 is a portion for executing the cleaning function for collecting debris and dust in a room, and is provided mainly with a not-shown dust collection container 15a, a filter unit 15b, and a cover unit 15c which covers the dust collection container and the filter unit (refer to FIG. 6). Moreover, an inflow path 31a which communicates with the intake port 31 and a discharge path 32a which guides air to the exhaust port 32 are included (refer to FIG. 5 and FIG. 6). On a side wall of the inflow path 31a, a light emitting unit 225a and a light receiving unit 225b of a transmissive photosensor are arranged so as to face each other (refer to FIG. 5). This photosensor functions as a dust level detection unit 225 which detects a degree of an amount of dust sucked from the intake port 31 together with air. When dust included in air flow passing through the inflow path is a large amount, light of the photosensor is obstructed by the dust, thus making it possible to detect the degree of the amount of the dust based on intensity of the light which reaches the light receiving unit 225b. Note that, a dust level may be decided by averaging the intensity of the light which has been detected by the light receiving unit 225b during a fixed period. In the discharge path, the electric air blower 115 is arranged. The electric air blower 115 generates air flow which sucks air from the intake port 31, guides the air into the dust collection container via the inflow path, and releases the air after dust collection outside from the exhaust port 32 via the discharge path.

The rotary brush 9 which rotates around a shaft center parallel to a bottom surface is provided in a back of the intake port 31, and the side brushes 10 which rotate around rotary shaft centers perpendicular to the bottom surface are provided in both the right and left sides of the intake port 31. The rotary brush 9 is formed of brushes erected in a spiral manner on an outer peripheral surface of a roller which is a rotary shaft. The side brush 10 is formed by providing a brush bundle in a radial manner at a lower end of the rotary shaft. Note that, the rotary shaft of the rotary brush 9 and the rotary shafts of a pair of the side brushes 10 are pivoted to a part of the bottom plate 2a of a housing 2 and coupled with a brush motor 119 provided in a vicinity thereof via a power transmission mechanism including a pulley and a belt.

Further, the self-propelled vacuum cleaner 1 according to this embodiment is provided with an ion generation function as an additional function. In the discharge path, an ion generation unit 117 is provided. When the ion generation unit 117 operates, air flow released from the exhaust port includes ions generated by the ion generation unit 117 (which may be, for example, Plasmacluster ions (registered trademark) or negative ions). Air including the ions is discharged from the exhaust port 32 provided on a top surface of the housing 2. With the air which includes the ions, bacteria elimination and deodorization in a room are performed. Moreover, it is also known that negative ions have a relaxing effect on people. At this time, the air is exhausted from the exhaust port 32 backward and obliquely upward, so that a whirl of dust on a floor surface is prevented, thus making it possible to improve cleanliness in a room. In addition, it is possible to eliminate static electricity from dust, thus making it possible to reliably perform disposal of the collected dust.

Note that, a part of the ions generated by the ion generation unit 117 may be guided to the inflow path. The ions are thereby included into the air flow guided from the intake port 31 to the inflow path, thus making it possible to perform bacteria elimination and deodorization of the dust collection container and the filter which are included in the dust collection unit 15 and which are not-shown.

The voice output unit 221 generates a voice signal under control of the message control unit 11a by using voice data stored in the message storage unit 11c in advance, and outputs the generated voice signal from the speaker 223. The voice is used for prompting a user to perform an operation, notifying a state of the self-propelled vacuum cleaner 1, and additionally achieving communication. Particularly, in the invention, in response to a change of a type of an effect of surrounding temperature and humidity on human health risk and sensation of comfort, the user is notified of it with the voice.

The surrounding environment detection unit 227 is a circuit which has a temperature sensor 227a and a humidity sensor 227b and detects temperature and humidity of surroundings of an electronic device. The control unit 11 successively monitors the surrounding environment detection unit 227 by polling or interruption processing to obtain information on the surrounding temperature and humidity.

The human sensing unit 229 is a circuit which detects a person present in the surroundings. Specific modes of the human sensing unit 229 include a camera module and an image analysis circuit, a microphone and an unspecified voice recognition circuit, a human-sensing sensor, or a combination of all or a part of them.

### Embodiment 1

Subsequently, processing executed by the message control unit 11a will be described. In this embodiment, the message control unit 11a is included in the control unit 11, and, when the microcomputer executes a predetermined control program stored in the ROM in advance, a function thereof is realized. The aforementioned ROM may store data related to the correlation storage unit 11b and the message storage unit 11c in advance.

The aforementioned microcomputer performs multitask processing for control programs of a plurality of modules to thereby realize a function as the control unit 11. When the aforementioned microcomputer executes a specified module among the above-described plurality of modules, the function of the message control unit 11a is realized.

Hereinafter, processing according to the message control portion 11a, which is characteristic of the invention, will be described.

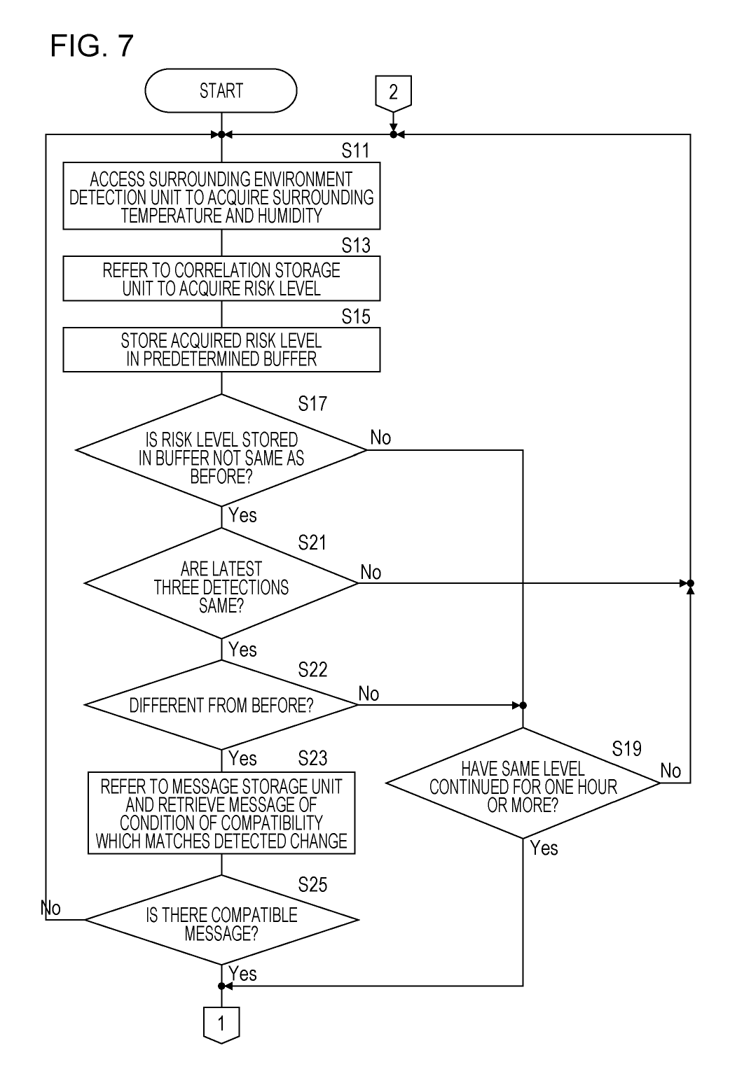

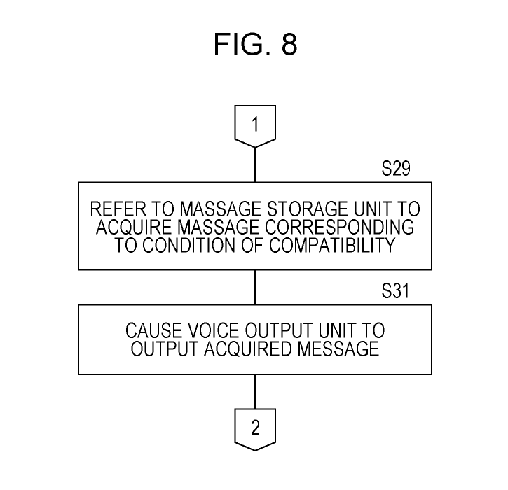

FIG. 7 and FIG. 8 are flowcharts illustrating one example of the processing executed by the message control unit 11a. In this embodiment, the surrounding environment detection unit 227 provides surrounding temperature and humidity which are detected by the temperature sensor 227a and the humidity sensor 227b at all times, and the message control unit 11a accesses the surrounding environment detection unit 227 repeatedly to acquire the latest temperature and humidity each time. This is so-called polling processing. As a modified example, temperature and humidity may be acquired by periodical interruption processing, periodical task switching, or the like.

After initialization processing of a variable or the like (not illustrated in FIG. 7), the message control unit 11a accesses the surrounding environment detection unit 227 to acquire surrounding temperature and humidity which are updated (step S11 in FIG. 7). The correlation storage unit 11b is then referred to. The correlation storage unit 11b stores data of effects of surrounding temperature and humidity on human health risk and sensation of comfort in advance.

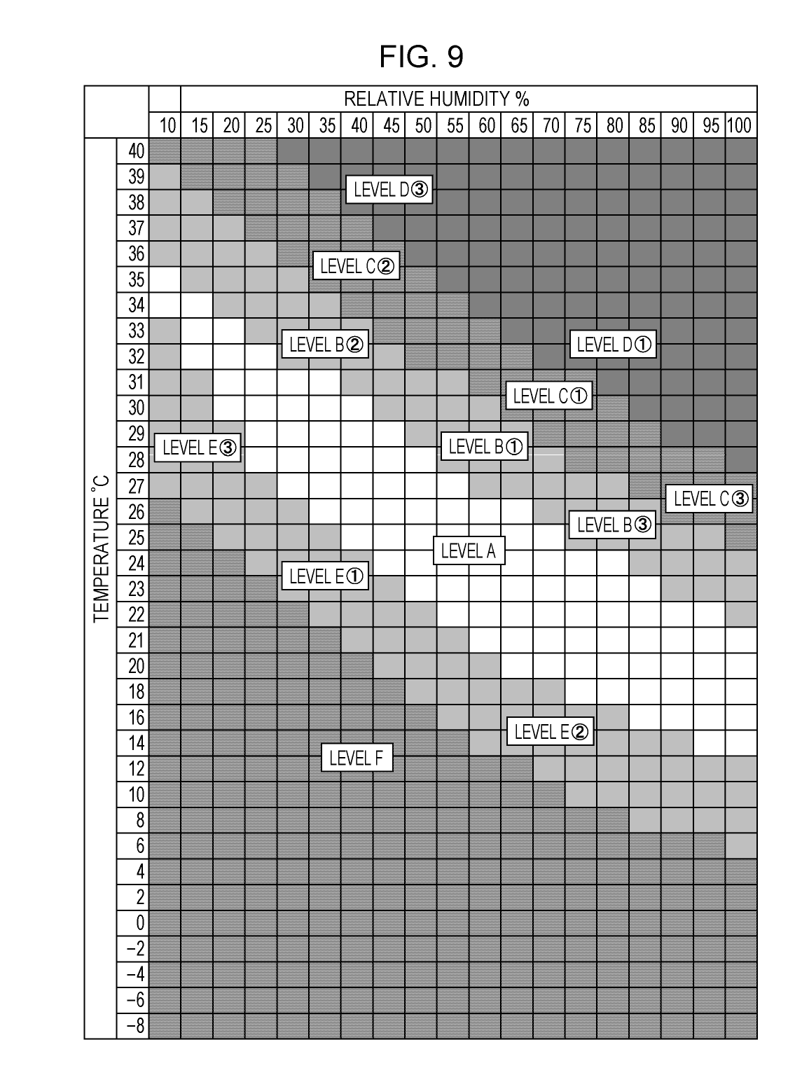

FIG. 9 is an explanatory diagram illustrating one specific example of data stored by the correlation storage unit 11b. In FIG. 9, as a specific example, a risk level of heat stroke or influenza in accordance with temperature and relative humidity is classified into six of A, B, C, D, E, and F to be stored. Further, regarding risk at level B, for example, the risk level is subdivided into three divisions of 1 to 3 in accordance with a combination of temperature and humidity.

The message control unit 11a refers to the correlation storage unit 11b and uses the temperature and the humidity which are acquired at step S11 described above to acquire the risk level and, in a case where there is a division which is further subdivided, the division (step S13). For example, when the temperature is 27° C. and the relative humidity is 60%, the risk level is level B and the division is 3. Moreover, when the temperature is 30° C. and the relative humidity is 70%, the risk level is level C and the division is 1.

The aforementioned processing at step S13 corresponds to determining the type of the effect of surrounding temperature and humidity on human health risk and sensation of comfort in the invention.

The message control unit 11a stores the acquired risk level and the division thereof in a predetermined area of the RAM. This area functions as a FIFO buffer for storing a risk level and a division thereof which have been acquired before (step S15). A depth of the FIFO buffer is a depth for storing three detections in this practical example, which is merely one example and does not limit the invention.

Subsequently, the message control unit 11a judges whether or not all of the risk level and the division which are stored in the above-described buffer are different from the risk level and the division which have been detected before (step S17). Note that, “the risk level and the division which have been detected before” are stored in a predetermined area of the variable of a work RAM by the message control unit 11a for update. The update will be described below.

In the case of being same (No at step S17), routine proceeds to step S19, and whether or not the same risk level and division have continued for one hour or more is examined (step S19). A period of one hour may be measured by using a timer included in the control unit 11 (hereinafter, referred to as a first timer). One hour is merely one example and does not limit the invention.

When the same risk level and division have not continued for one hour yet (No at step S19), the routine returns to step S11 described-above, polling of surrounding temperature and humidity is repeated, and a risk level and a division which correspond to the updated temperature and humidity are stored in the FIFO buffer.

On the other hand, when the same risk level and division have continued for one hour or more (Yes at step S19), the routine proceeds to step S29 described below.

When all of the risk level and the division which are stored in the FIFO buffer are not same at step S17 described above (Yes at step S17), the message control unit 11a examines whether or not all of risk levels and divisions which have been acquired in latest three times are same (step S21). The number of times of three is merely one example and does not limit the invention.

In the case of not being same (No at step S21), the message control unit 11a judges that the risk level and the division are not in a substantially stable state, and the routine returns to step S11 described above to repeat polling.

For example, it is assumed that latest two risk levels and divisions which are stored in the FIFO buffer are in division 1 of level C, but a risk level and a division which are detected before them are in division 3 of level B. In this case, the message control unit 11a judges that a change from division 3 of level B into division 1 of level C is made, but there is still a possibility of reciprocating on a boundary, so that a state is not stable, followed by returning to step S11 to repeat the polling.

On the other hand, when the risk levels and the divisions which have been acquired in the latest three times are same (Yes at step S21), the message control unit 11a judges whether a risk level and a division which have been acquired before them are different from those of the latest three times (step S22). Note that, “the risk level and the division which have been acquired before” are stored in the predetermined area of the variable for update as described for the processing of the aforementioned step S17.

When the risk levels and divisions which have been acquired in the latest three times are same and are different from “the risk level and the division which have been acquired before” (Yes at step S22), the message control unit 11a executes following processing. That is, in this case, it is judged that a change into the risk levels and the divisions which have been acquired in the latest three times is definitive, and, by referring to conditions of compatibility of the message storage unit 11c, whether a message of a condition of compatibility which matches the above-described change is stored is examined (step S23). In addition, the above-described first timer is reset, and the predetermined area of the variable in which “the risk level and the division which have been acquired before” described for the aforementioned processing of steps S17 and S22 are stored is updated to the risk levels and the divisions which have been acquired in the latest three times.

On the other hand, when the latest three detections and “the risk level and the division which have been acquired before” are same (No at step S22), the routine proceeds to step S19 described above.

In a case where, as a result of retrieving the message at step S23 described above, there is no compatible message (No at step S25), the routine proceeds to step S11 described above to repeat the polling.

On the other hand, in a case where there is a compatible message (Yes at step S25), the message control unit 11a acquires a message corresponding to the condition of compatibility from among messages stored in the message storage unit 11c (step S29).

The voice output unit 221 is then caused to output the acquired message. After that, the routine returns to step S11 of FIG. 7 to repeat the polling.

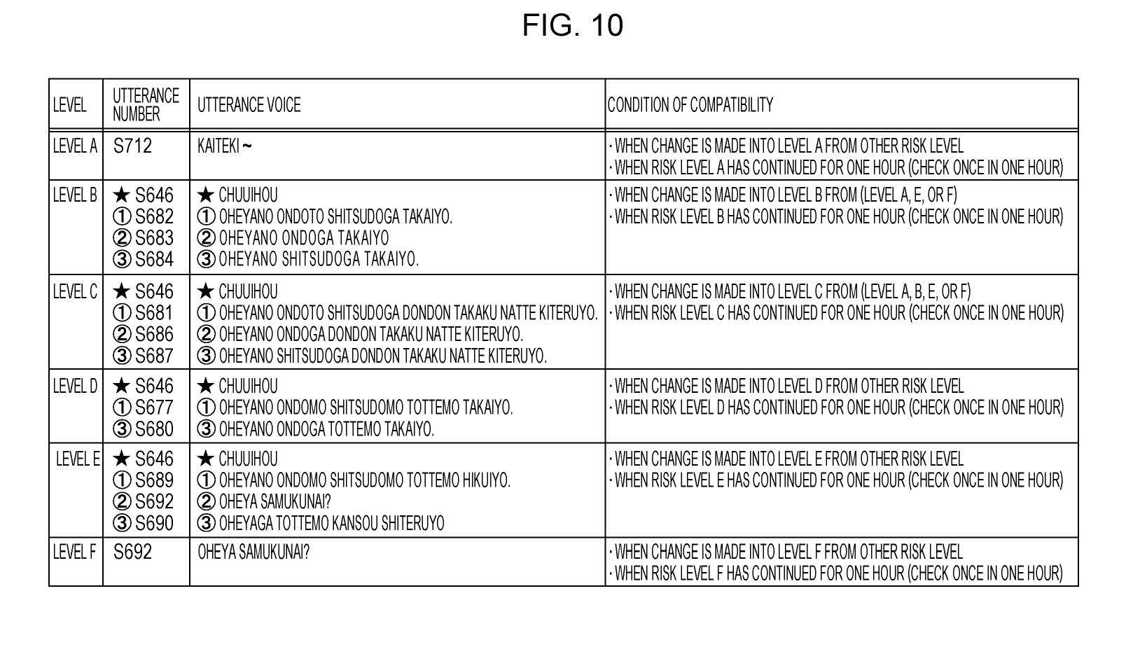

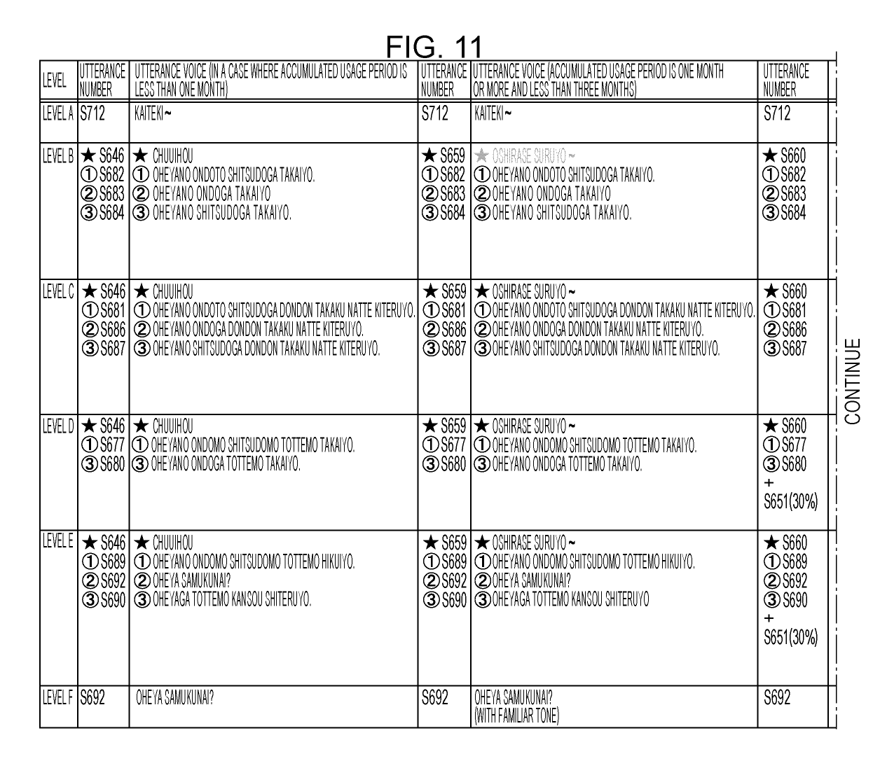

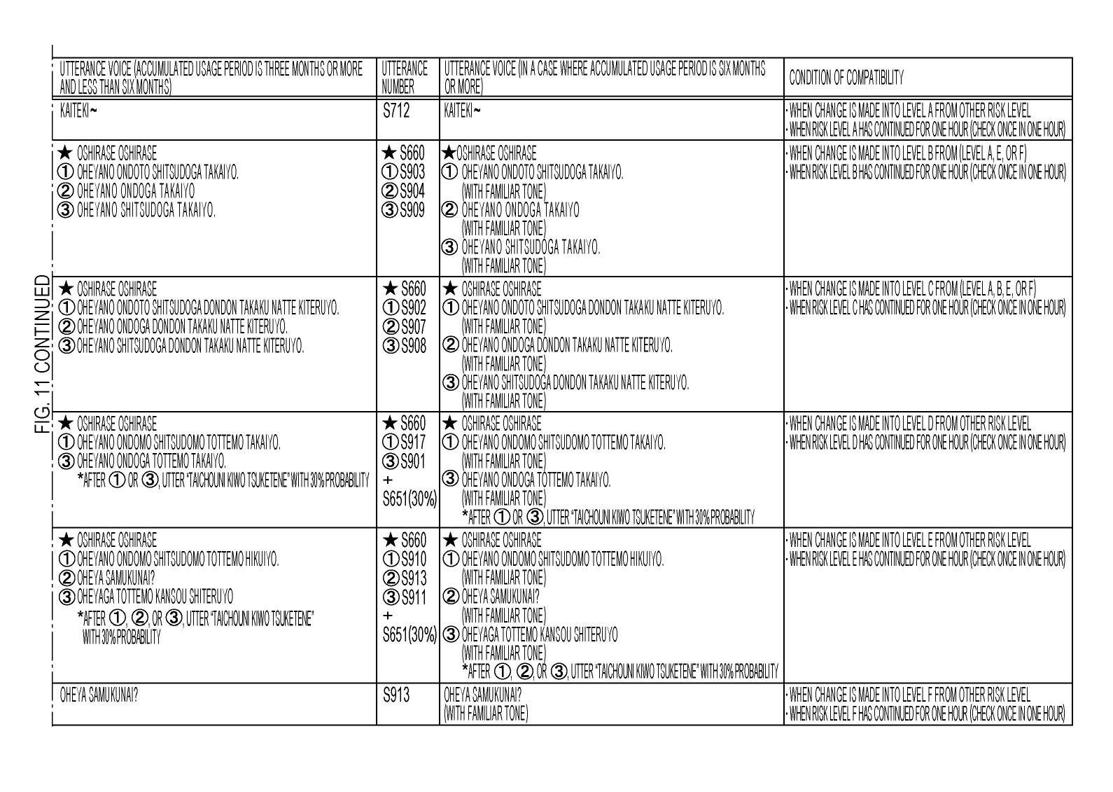

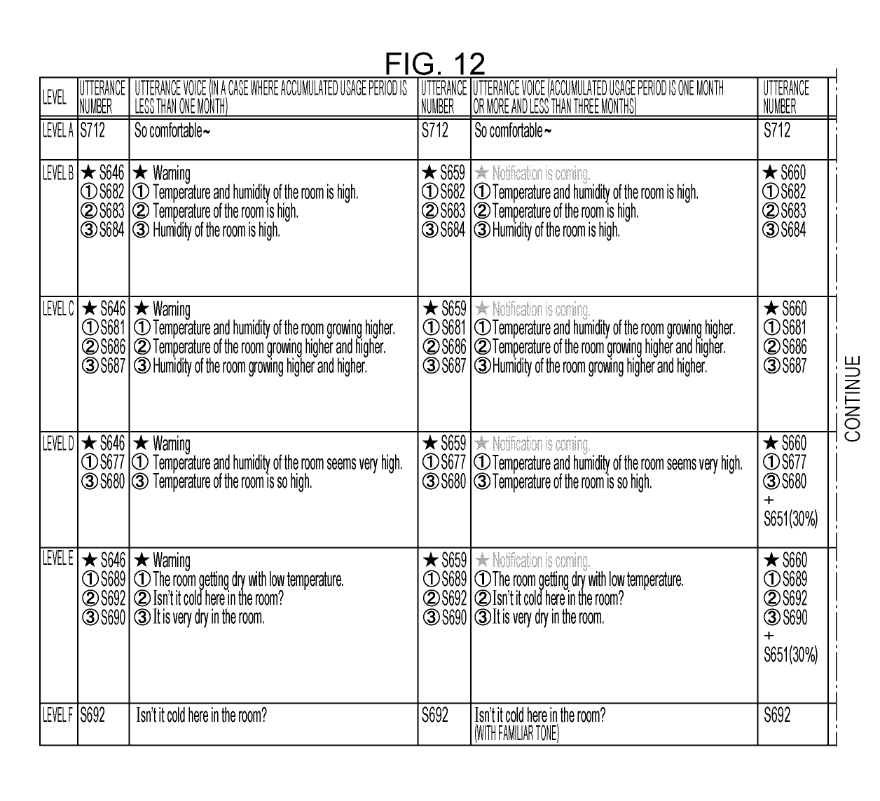

FIG. 10 is an explanatory diagram illustrating a way that the message storage unit 11c stores Japanese messages corresponding to each of the risk levels and the subdivided divisions of the risk levels. In FIG. 10, a longitudinal direction of a table indicates different risk levels and divisions and each message corresponding thereto. A lateral direction of the table indicates utterance voices and conditions of compatibility of each message. In a case where detected temperature and humidity satisfy any of the conditions of compatibility, the message control unit 11a selects a corresponding message.

For example, it is assumed that all of latest three risk levels and divisions which are stored in the FIFO buffer are in division 1 of level C, and “the risk level and the division which have been acquired before” is in division 3 of level B. In this case, a condition of compatibility of “when a change is made into level C from (level A, B, E, or F)” in the message storage unit 11c, which is related to level C, matches the change. Therefore, the message control unit 11a generates messages of utterance numbers of S646 and S681 which is related to division 1. That is, following a voice of “Chuuihou (Warning)”, a voice of “Oheyano ondoto shitsudoga dondon takaku natte kiteruyo (Temperature and humidity of the room growing higher)” is output.

In FIG. 9, level A indicates the most comfortable environment. As an example above, the change of the risk level and the division from division 3 of level B into division 1 of level C is a change which increases discomfort. On the contrary, change from division 1 of level C into division 3 of level B is a change which increases comfort. However, when searching for a condition of compatibility matching the change by referring to FIG. 10, a condition of compatibility related to level B is set as “when a change is made into level B from (level A, E, or F)”, which does not match the change from level C into level B. That is, the condition of compatibility related to level B is set not to generate a message in the case of the change which increases comfort. A condition of compatibility related to level C is similar. Since the change which increases comfort is not regarded as “a caution”, care is taken so as not to generate an unnecessary message.

### Embodiment 2

In this embodiment, description will be given for a mode in which a content of a message is changed according to an accumulated period.

FIG. 11 is an explanatory diagram illustrating a way that the message storage unit 11c stores Japanese messages corresponding to each of the risk levels and the subdivided divisions of the risk levels. In FIG. 11, a longitudinal direction of a table indicates different risk levels and divisions and each message corresponding thereto. A lateral direction of the table indicates divisions of an accumulated usage period of the self-propelled vacuum cleaner 1 and each message corresponding to each of the divisions. Further, in a rightmost column of the table, conditions of compatibility of respective messages are indicated. In a case where detected temperature and humidity satisfy any of the conditions of compatibility, the message control unit 11a selects a corresponding message according to the accumulated usage period. The accumulated usage period is acquired by, when power is supplied to the self-propelled vacuum cleaner 1 for the first time after being shipped from a factory, starting a not-shown timer of the microcomputer (hereinafter, referred to as a second timer) and thereafter referring to a value of the second timer.

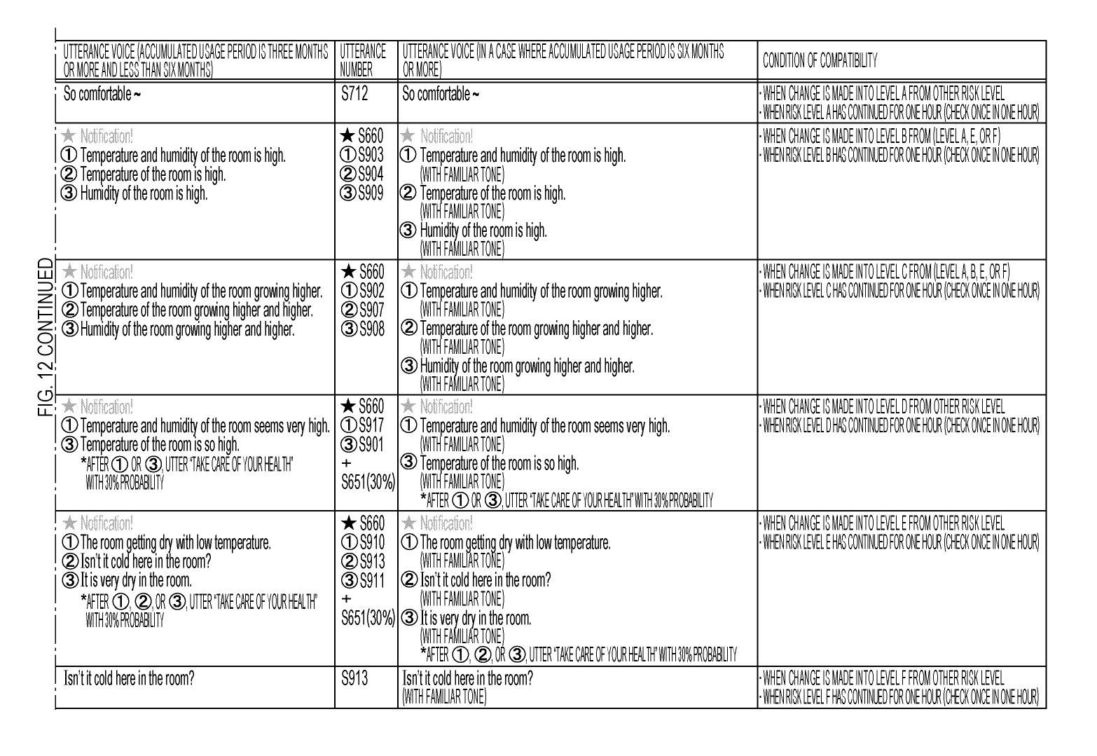

FIG. 12 is an explanatory diagram illustrating English messages corresponding to FIG. 11.

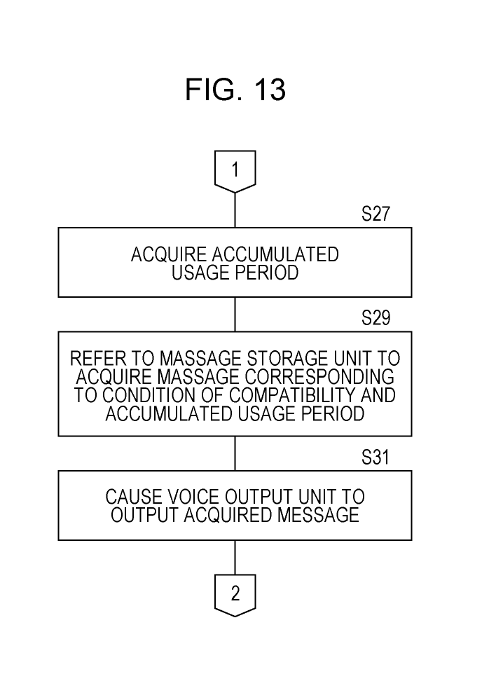

According to this embodiment, the message control unit 11a executes processing illustrated in FIG. 13 instead of processing at steps S29 and S31 of FIG. 8 which are described in the embodiment 1. That is, as described in the embodiment 1, in a case where there is a compatible message at step S25 of FIG. 7, the routine proceeds to step S27 of FIG. 13. The message control unit 11a then refers to the second timer and acquires the accumulated usage period of the self-propelled vacuum cleaner 1 (step S27 of FIG. 13). Among messages, the condition of compatibility of which is satisfied by the detected temperature and humidity, of messages stored in the message storage unit 11c, one in accordance with the acquired accumulated usage period is acquired (step S29).

The voice output unit 221 is then caused to output the acquired message (step S31). The routine thereafter returns to step S11 of FIG. 7 to repeat the polling.

### Embodiment 3

In this embodiment, the message control unit 11a suppresses generation of a message during a period when the control unit 11 operates the aforementioned propelling unit and the aforementioned dust suction and collection unit. For example, during cleaning operation, generation of heat or air flow utters due to operation of the propelling unit or the dust suction and collection unit, so that tasks illustrated in FIG. 7 and FIG. 8 are not executed during that period, the aforementioned tasks are executed in a state where the generation of heat and the air flow are stable, for example, during standby, and a message is generated based on temperature and humidity which are detected successively.

### Embodiment 4

In this embodiment, the message control unit 11a does not execute the tasks illustrated in FIG. 7 and FIG. 8 during a period when the human sensing unit 229 does not sense a person present in the surroundings, and suppresses generation of a message.

When there is no one in the surroundings, a message is not heard by anyone even if being generated, which is wasteful from a viewpoint of power consumption or a processing load of the microcomputer, so that a message is not to be generated.

### Embodiment 5

In this embodiment, description will be given for a mode in which the control unit 11 performs remote operation of an air conditioning device in a room based on a type and a division of a risk level determined by the message control unit 11a based on surrounding temperature and humidity. Here, the air conditioning device includes not only a so-called air conditioner but a device which performs processing or adjustment related to air, for example, such as an air cleaner.

The radio signal communication unit 217 is able to transmit a radio signal equivalent to a signal of a remote controller of the air conditioning device in a room. The aforementioned radio signal may be learned by causing the radio signal communication unit 217 to read the remote controller of the aforementioned air conditioning device by a user. More specifically, the control unit 11 is set to be capable of executing a setting menu for learning a radio signal. The aforementioned setting menu is to realize a learning function similar to that of a learning remote controller which is commercially available. When the user sends a radio signal from the remote controller of a device desired to learn toward the self-propelled vacuum cleaner 1, the radio signal communication unit 217 receives the radio signal, and the control unit 11 analyzes a pattern of the radio signal to store in a nonvolatile memory. The radio signal which is learned once is able to be transmitted to the radio signal communication unit 217 by the control unit 11 as necessary.

The setting menu for storing, in advance, a position which is preferable for the self-propelled vacuum cleaner 1 to transmit the radio signal to the air conditioning device in the room is provided in advance. The user puts the self-propelled vacuum cleaner 1 at the position from which the radio signal (for example, a signal of infrared light) transmitted from the self-propelled vacuum cleaner 1 reaches the air conditioning device in the room and executes the aforementioned setting menu.

The aforementioned setting menu is realized when the control unit 11 executes a control program. A content of the aforementioned setting menu includes followings, for example. First, the signal of the remote controller is transmitted at the position to cause the user to confirm that the air conditioning device is able to be controlled. After the user sends an instruction that the confirmation is finished to the self-propelled vacuum cleaner 1, the self-propelled vacuum cleaner 1 searches for the charging stand installed in the room to return thereto, and stores a route for returning in the ROM which is a rewriteable nonvolatile memory. After finishing returning to the charging stand, the setting menu finishes.

Thereafter, when the message control unit 11a judges that, for example, a change is made from division 3 of level B into division 1 of level C while the self-propelled vacuum cleaner 1 is charging on the charging stand or during standby, the control unit 11 causes the self-propelled vacuum cleaner 1 to travel so as to reversely track the route which is stored by the aforementioned setting menu and to move to the position from which the radio signal reaches the air conditioning device. The radio signal is then transmitted to the air conditioning device. In the case of this example, temperature changes to be higher, so that a signal of an instruction for starting cooling operation with a predetermined setting temperature is transmitted to the air conditioning device.

For an elderly person or an infant, there is a case where it is difficult to operate the air conditioning device by himself or herself or a case it is not preferable to perform operation by himself or herself, but according to this mode, the self-propelled vacuum cleaner 1 controls air conditioning of the room autonomously so that environment does not become harsh.

Note that, while the human sensing unit 229 senses no one in the surroundings, control of the air conditioning device may be suppressed so that wasteful power consumption is suppressed.

### Embodiment 6

In this embodiment, the self-propelled vacuum cleaner 1 is provided with a communication unit for communicating with an external apparatus such as an information providing apparatus, for example, via the Internet, and description will be given for a case where the information providing apparatus is provided with a part of the functions of the self-propelled vacuum cleaner 1 of each of the embodiments described above.

For example, in the case where the aforementioned external apparatus stores the data stored by the correlation storage unit, which is described in FIG. 9, or the data of the Japanese messages corresponding to each of the risk levels and the divisions, which is described in FIG. 10, the self-propelled vacuum cleaner 1 may be configured so as to communicate with the external apparatus as appropriate for referring to various data.

As described above,

(i) an electronic device according to the invention is provided with a surrounding environment detection unit which detects surrounding temperature and humidity, a message control unit which determines a type of an effect of the temperature and the humidity which are detected by the surrounding environment detection unit on human health risk and/or sensation of comfort and generates a message in accordance with the type, and a voice output unit which outputs the generated message, in which the message control unit generates the message in response to a change of the determined type of the effect.

In the invention, the electronic device includes the self-propelled vacuum cleaner described in the embodiments, and, without limitation thereto, includes a household electric robot such as a washing machine or a household electric appliance such as a refrigerator or an air conditioning device, for example.

The surrounding environment detection unit successively detects the temperature and the humidity of the surroundings of the electronic device. A sensor which detects the temperature and the humidity may be arranged either inside or outside the electronic device, as long as being able to measure the temperature and the humidity of air surrounding the electronic device without being affected strongly by generation of heat or blowing of air by the electronic device. In addition, detecting successively means to perform detection many times with a lapse of time and intervals of time for detection and intervals therebetween may be fixed or random.

Specific examples of the effect of the surrounding temperature and humidity on human health risk include WBGT at which heat stroke occurs and onset risk of influenza as described above, but there is no limitation thereto. A correlation storage unit which classifies the effect into several stages of significance (levels) for storage may be provided. As a specific mode, in the above-described embodiment, onset risk of heat stroke or influenza is classified into, for example, six stages of levels A to F as in FIG. 9, and subdivided into divisions such that levels B, C, and E are subdivided into three divisions and level D is subdivided into two divisions, and is stored in a predetermined storage area of a nonvolatile memory (corresponding to the correlation storage unit described above) in advance.

The message control unit determines at which level the effect of the detected temperature and humidity is by referring to the correlation storage unit, for example, and generates the message when a change from a level which has been determined based on the temperature and humidity which have been detected before is made.

However, without limitation thereto, for example, when a same level has been continued for a predetermined period, the message control unit may generate the message in accordance with the level.

Further, preferable modes of the electronic device of the invention will be described.

(ii) The message control unit may generate the message for each change as to a change that increases the risk and/or discomfort among changes of the type of the effect, but may generate the message only for a limited change as to a change that decreases the risk and/or increases comfort.

Thereby, it is possible to generate the message each time as to the change that increases the risk and/or discomfort so that a user is able to take necessary measures, while reducing the message as to the change that decreases the risk and/or increases comfort so that the user does not feel annoyed.

(iii) A human sensing unit which senses a person present in the surroundings may be further provided, and when the human sensing unit does not sense a person, the message control unit may suppress generation of the message.

Thereby, when there is no one in the surroundings, generation of the message which is not heard by anyone is suppressed, thus making it possible to suppress wasteful processing and power consumption.

The message control unit may generate, after a same type has been detected for a predetermined period or number of times after a change of the type of the effect, which is determined based on the temperature and the humidity detected by the surrounding environment detection unit, was made, a message in accordance with the change.

Thereby, even when the type of the effect based on the detected temperature and humidity repeats reciprocation on a same boundary in a short period, it is possible to prevent a situation where the message is generated each time of crossing the boundary and a user is thereby confused.

In addition, a self-propelled vacuum cleaner of the invention may be (iv) a self-propelled vacuum cleaner including the above-described electronic device and further including a propelling unit which propels the self-propelled vacuum cleaner in an area to be cleaned, a dust suction and collection unit which sucks and collects dust, and a control unit which controls operation of the propelling unit and the dust suction and collection unit, in which the message control unit suppresses generation of the message during a period when the control unit operates the propelling unit and the dust suction and collection unit.

Thereby, it is possible to suppress the message when generation of heat or air flow occurs due to the operation of the propelling unit or the dust suction and collection unit, and to detect the temperature and the humidity, in a state where the generation of heat or the air flow is stable, for generating the message based on the detection.

(v) A remote operation unit for performing remote operation of an installed air conditioning device in a room may be further provided, and the control unit may control the operation of the propelling unit so that the self-propelled vacuum cleaner travels to a position predetermined for the remote control based on a change of the type of the effect, which is determined by the message control unit, and may control the remote operation unit so as to perform remote operation of the air conditioning device at the position.

Thereby, not only messages are generated based on a change in the surrounding temperature and humidity, but remote control of the air conditioning device is performed, so that it is possible to adjust temperature and humidity in a room so as to be comfortable.

Here, the air conditioning device includes not only an air conditioning apparatus (so-called air conditioner) but a device which performs adjustment or processing of air, for example, such as an air cleaner.

The preferable modes of the invention also include a combination of any of the above-described plurality of modes.

In addition to the above-described embodiments, there can be various modified examples of the invention. Such modified examples should not be deemed to be out of the scope of the invention. The invention should include all the modified examples within the meaning and range of equivalency of scope of the Claims.

### REFERENCE SIGNS LIST

1 self-propelled vacuum cleaner

2a bottom plate

2b top plate

2c bumper

2d rear-side side plate

3 lid

9 rotary brush

10 side brush

11 control unit

11a message control unit

11b correlation storage unit

11c message storage unit

12 rechargeable battery

14 obstruction detection unit

14CL left contact sensor

14CR right contact sensor

14F front side ultrasonic sensor

14L left side ultrasonic sensor

14R right side ultrasonic sensor

15 dust collection unit

15a dust collection container

15b filter unit

15c cover unit

18 front side floor surface detection sensor

19L left wheel floor surface detection sensor

19R right wheel floor surface detection sensor

21 power unit

22L left drive wheel

22R right drive wheel

26 rear wheel

31 intake port

31a inflow path

32 exhaust port

32a discharge path

115 electric air blower

117 ion generation unit

119 brush motor

217 radio signal communication unit

221 voice output unit

223 speaker

225 dust level detection unit

225b light receiving unit

227 surrounding environment detection unit

227a temperature sensor

227b humidity sensor

229 human sensing unit

1. An electronic device, comprising:
a surrounding environment detection unit which detects surrounding temperature and humidity;
a message control unit which determines a type of an effect of the temperature and the humidity which are detected by the surrounding environment detection unit on human health risk and/or sensation of comfort, and generates a message in accordance with the type; and
a voice output unit which outputs the generated message, wherein
the message control unit generates the message in response to a change of the determined type of the effect.

2. The electronic device according to claim 1, wherein the message control unit generates the message for each change as to a change that increases the risk and/or discomfort among changes of the type of the effect, but generates the message only for a limited change as to a change that decreases the risk and/or increases comfort.

3. The electronic device according to claim 1, further comprising
a human sensing unit which senses a person present in the surroundings, wherein
in a case where the human sensing unit does not sense a person, the message control unit suppresses generation of the message.

4. A self-propelled vacuum cleaner comprising the electronic device according to claim 1 and further including a propelling unit which propels the self-propelled vacuum cleaner in an area to be cleaned, a dust suction and collection unit which sucks and collects dust, and a control unit which controls operation of the propelling unit and the dust suction and collection unit, wherein
the message control unit suppresses generation of the message during a period when the control unit operates the propelling unit and/or the dust suction and collection unit.

5. The self-propelled vacuum cleaner according to claim 4, further comprising
a remote operation unit which performs remote operation of an installed air conditioning device in a room, wherein
the control unit controls the operation of the propelling unit so that the self-propelled vacuum cleaner travels to a position predetermined for the remote control based on a change of the type of the effect, which is determined by the message control unit, and controls the remote operation unit so as to perform remote operation of the air conditioning device at the position.
